(19) United States
(12) Patent Application Publication
(10) Pub. No.: US 2018/0036097 A1
(43) Pub. Date: Feb. 8, 2018

(54) Dental Precision Procedural Method and System

(71) Applicant: Yang Soo Kim, Seoul (KR)

(72) Inventor: Yang Soo Kim, Seoul (KR)

(21) Appl. No.: 15/554,183

(22) PCT Filed: Apr. 27, 2016
(86) PCT No.: PCT/KR2016/004379

§ 371 Date: Aug. 28, 2017

(30) Foreign Application Priority Data
Apr. 30, 2015 (KR) 10-2015-0061570

(51) Int. Cl. A61C 1/00; A61C 9/00; A61C 1/08; A61C 3/02

(52) U.S. Cl. CPC A61C 1/0015; A61C 3/02; A61C 9/0046; A61C 1/082

(57) ABSTRACT

A dental precision procedural method and system are disclosed. The dental precision procedural method may include creating information on a 3D oral image of a patient; creating a procedural fixture device to fixate the patient's mouth when performing a procedure of removing tooth of the patient based on the information on the 3D oral image; and moving a hand piece to a subject tooth for removal of the patient based on the information on the 3D oral image, and performing the procedure of removing tooth on the subject tooth for removal.

### FIELD

The present invention relates to a procedural method and system, and more particularly, to a dental precision procedural method and system.

### BACKGROUND

Prosthetics refers to replenishing large substantial tooth loss or deterioration of oral function and dysmorphism caused by the tooth loss in the dental field, with artifacts, thereby recovering the dental function.

If there is tooth decay due to cavity or a tooth falls out or breaks due to gum disease, accident and the like, prosthetics treatment may be performed in order to restore the defective tooth to its original form.

Types of tooth prosthetics include fixed prosthetics and removable prosthetics. Fixed prosthetics is performed when there is no tooth that has fallen out but there is cavity or a tooth is broken and thus needs to be reinforced, or when one or two teeth have fallen out and thus artificial teeth need to be made and placed into, whereas removable prosthetics is made into a structure that is attachable/detachable just like dentures. Types of fixed prosthetics include crown, bridge, resin, inlay, amalgam and the like. Crown is the type of prosthetics that may be covered on a tooth using gold, ceramic or the like in order to prevent the tooth from breaking after a tooth endodontic treatment, bridge is the type of prosthetics where, after a tooth is extracted due to cavity or external injury, adjacent teeth at both sides of the tooth are carved off by a suitable amount and an artificial tooth is connected between side teeth at the left and the right using those side teeth as bridges, and resin, inlay and amalgam are types of prosthetics where, when a tooth is partially damaged due to cavity, the portion with the cavity is carved off and is filled with resin, inlay and amalgam and the like.

Of the aforementioned, crown and bridge prosthetics treatment processes are performed in the following way. First, a portion of a tooth is removed as much as the amount of space where prosthetics is to be placed into. When covering a tooth with crown or bridge, since the resulting tooth should not be bigger than the original natural tooth, enamel or dentine of the tooth is removed by an amount that is to be filled with the crown or bridge. Such removing of tooth secures the space to mount the prosthetics, and provides retention force so that the prosthetics does not fall out. Further, impression taking and bite taking are performed, and then a temporary crown is produced. Impression taking refers to recording the necessary form of a tooth or oral tissue in a female pattern when performing a dental treatment of repairing the tooth or performing prosthetics and the like. Here, the current tooth condition is reproduced as a model, and then the crown or bridge is produced. In the case of bite taking, the current tooth condition is reproduced as a model in order to check the occlusal condition of the upper teeth and lower teeth. The temporary crown is covered on a tooth until a crown or a final prosthetics is mounted on the tooth of which a portion has been removed. The temporary crown protects the tooth to be treated until the final prosthetics is mounted, prevents secondary infection and prevents the tooth from moving. After producing the temporary crown, prosthetics such as crown, bridge and the like is produced. Prosthetics is generally produced in factories specialized in producing dental prosthetics. When producing the crown or bridge is completed, the prosthetics is mounted on the tooth from which a portion has been removed, using permanent adhesive cement.

However, as aforementioned, a treatment process of crown and bridge prosthetics is performed in numerous steps, and thus there is inconvenience for a patient to visit the hospital numerous times from the first visit until the final prosthetics is mounted, and also a disadvantage that it takes a long time until the final prosthetics is completed. Further, even though the condition or form of the tooth from which a portion has been removed so that it can be covered with the crown or bridge is closely related to the coherence between the tooth and the prosthetics and the period for which the prosthetics can be used without falling out or breaking, the condition or form of the tooth from which a portion has been removed is determined by the medical team's experience or level of skill, thus leading to a problem where the crown or bridge may easily fall out or break if a portion of the tooth is removed by a medical team with poor experience or low level of skill.

### SUMMARY

Therefore, a purpose of the present disclosure is to solve the aforementioned problems of prior art, that is, to provide a dental precision procedural method and system capable of automatically performing a procedure of removing tooth based on a 3D oral image of a user produced in consideration of the oral appearance of the user.

Further, another purpose of the present disclosure is to provide a dental precision procedural method and system capable of performing an exact procedure of removing tooth regardless of the human level of skill, and without anesthesia that has to be performed in case too much tooth is removed, and with reduced amount of tooth removed, and that allows a prosthetics, for the process upon removing a portion of the tooth, to be prepared in advance.

A dental precision procedural method according to an embodiment of the present disclosure for achieving the aforementioned purposes may include creating information on a 3D oral image by photographing a patient's mouth; creating a procedural fixture device to fixate the patient's mouth when performing a procedure of removing tooth of the patient based on the information on the 3D oral image; and moving a hand piece to a subject tooth for removal of the patient based on the information on the 3D oral image, and performing the procedure of removing tooth on the subject tooth for removal.

Meanwhile, the hand piece may be moved to the subject tooth for removal by a driving unit, and the driving unit may move the hand piece in 3 axis directions based on 3D coordinate information on the subject tooth for removal obtained based on the information on the 3D oral image.

Further, the driving unit may determine whether or not to move the hand piece to a target point indicated on the procedural fixture device before moving the hand piece to the subject tooth for removal, and adjust a zero point between the 3 axis movement of the driving unit and the 3D coordinate information on the subject tooth for removal.

Further, the creating the information on the 3D oral image may include determining a teeth template image for creating the information on the 3D oral image based on a plurality of oral image information of the patient; matching each template tooth included in the teeth template image and each tooth of the patient included in the plurality of oral image information; obtaining the 3D coordinate information on the each tooth of the patient; obtaining shape revision information on the each tooth of the patient; and creating the information on the 3D oral image based on the 3D coordinate information on the each tooth of the patient and the shape revision information on the each tooth of the patient, wherein the shape revision information may include information on a difference between a shape of the each template tooth and a shape of the each tooth of the patient included in the oral image information.

Further, the teeth template image may be determined based on the patient's gender, the patient's age, information on characteristics of an upper jaw and a lower jaw of the patient, and presence of a wisdom tooth of the patient.

A dental precision procedural system according to an embodiment of the present disclosure may include a 3D oral image creating device configured to create information on a 3D oral image of a patient; a procedural fixture device creating device configured to create a procedural fixture device to create the patient's mouth when performing a procedure of removing tooth of the patient based on the information on the 3D oral image; and an automatic tooth removing device configured to move a hand piece to a subject tooth for removal of the patient based on the information on the 3D oral image, and perform the procedure of removing tooth.

Meanwhile, the automatic tooth removing device may include a driving unit, the hand piece may be moved to the subject tooth for removal by the driving unit, and the driving unit may move the hand piece in 3 axis directions based on 3D coordinate information of the subject tooth for removal obtained based on the information on the 3D oral image.

Further, the driving unit may determine whether or not to move the hand piece to a target point indicated on the procedural fixture device before moving the hand piece to the subject tooth for removal, and adjust a zero point between the 3 axis movement of the driving unit and the 3D coordinate information of the subject tooth for removal.

Further, in claim 3, the 3D oral image creating device may be configured to determine a teeth template image for creating the information on the 3D oral image based on a plurality of oral image information of the patient, match each template tooth included in the teeth template image and each tooth of the patient included in the plurality of oral image information, obtain the 3D coordinate information on the each tooth of the patient, obtain shape revision information on the each tooth of the patient, and create the information on the 3D oral image based on the 3D coordinate information on the each tooth of the patient and the shape revision information on the each tooth of the patient, wherein the shape revision information may include information on a difference between a shape of the each template tooth and a shape of the each tooth of the patient included in the oral image information.

Further, the teeth template image may be determined based on the patient's gender, the patient's age, information on characteristics of an upper jaw and a lower jaw of the patient, and presence of a wisdom tooth of the patient.

According to one aspect of the aforementioned present disclosure, the procedure of removing tooth may be performed automatically based on the procedural fixture device produced in consideration of the oral appearance of the user and the 3D oral image of the user. Therefore, the procedure for removing tooth may be performed accurately and regardless of the human level of skill. Further, when using such an automatic tooth removing method, anesthesia to be performed in case too much tooth is removed may be unnecessary. Further, the amount of tooth being removed in the procedure of removing tooth may be reduced, and the prosthetics, for the process upon a portion of the tooth is removed, may be prepared in advance.

### BRIEF DESCRIPTION OF THE DRAWINGS

FIG. 1 is a view illustrating the concept of a method for removing tooth according to an embodiment of the present disclosure.

FIG. 2 is a view illustrating the concept of a method for creating a procedural fixture device according to an embodiment of the present disclosure.

FIG. 3 is a view illustrating the concept of a method for obtaining a patient's 3D oral image of according to an embodiment of the present disclosure.

FIG. 4 is a view illustrating the concept of an automatic tooth removing device according to an embodiment of the present disclosure.

FIG. 5 is an image illustrating an operation of removing tooth of the automatic tooth removing device according to an embodiment of the present disclosure.

FIG. 6 is a view illustrating the concept of a zero point adjusting process according to an embodiment of the present disclosure.

FIG. 7 is a view illustrating the concept of the method for removing tooth based on a hand piece inside a mouth according to an embodiment of the present disclosure.

FIG. 8 is a block diagram illustrating a 3D oral image creating device according to an embodiment of the present disclosure.

FIG. 9 is a block diagram illustrating a procedural fixture device creating device according to an embodiment of the present disclosure.

FIG. 10 is a block diagram illustrating the automatic tooth removing device according to an embodiment of the present disclosure.

### DETAILED DESCRIPTION

Hereinbelow, the present disclosure will be explained in detail with reference to the attached drawings illustrating certain exemplary embodiments for implementing the present disclosure. These embodiments will be explained in detail sufficient for a person skilled in the art to implement the present disclosure. It should be understood that the various embodiments of the present disclosure are different from one other but need not be mutually exclusive to one other. For example, certain shapes, structures and characteristics of an embodiment disclosed herein may be realized through other embodiments without departing from the spirit and scope of the present disclosure. Further, it should be understood that the position or arrangement of individual configurative elements in each disclosed embodiment may be altered without departing from the spirit and scope of the present disclosure. Therefore, the detailed description hereinbelow is not intended to have limited meaning, but rather, the scope of the present disclosure, if described appropriately, is limited by the attached claims together with the scope of any range equivalent to the claims. Like reference numerals indicate like functions or similar functions throughout various aspects.

Hereinbelow, preferable embodiments of the present disclosure will be explained in further detail with reference to the drawings.

A procedure being used for dental treatment (for example, implant, endodontic treatment, orthodontics and the like) needs a step of removing a portion of tooth. The current procedure for removing tooth may be performed based on a removing procedure through a doctor's hand piece. In a procedure of removing tooth, a problem may occur due to removing too much tooth. The reason too much natural tooth may be removed is because different dentists have different levels of skill and doctors perform the procedure of removing tooth by hand.

In an embodiment of the present disclosure, there is disclosed an automatic method for removing tooth where such a problem of removing by human hand is improved. When using such an automatic tooth removing method, anesthesia, that has to be performed in case too much tooth is removed, becomes unnecessary, and the amount of tooth removal may be reduced. Not only that, the prosthetics to be used in an additional treatment procedure after removing the tooth may be prepared in advance, thereby accelerating the dental treatment.

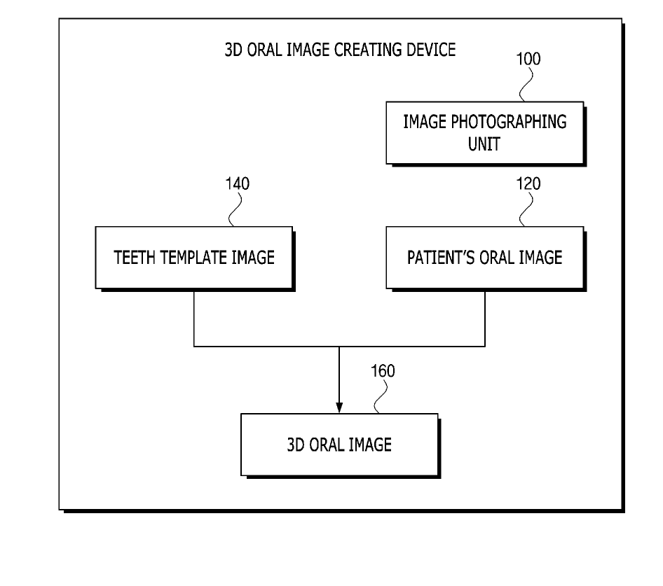

FIG. 1 is a view illustrating the concept of the tooth removing method according to an embodiment of the present disclosure.

FIG. 1 discloses a method for creating or producing a procedural fixture device for a procedure of removing tooth. The procedural fixture device is a device for keeping a patient's mouth still in a process of removing tooth.

Referring to FIG. 1, a 3D image of the patient's mouth may be obtained in order to create the procedural fixture device for automatic removal of tooth. Hereinbelow, the device for obtaining a 3D image of a patient's mouth will be referred to as a 3D oral image creating device.

The 3D oral image creating device may create a 3D image of a patient's mouth in various methods.

For example, the 3D oral image creating device may photograph numerous parts of a patient's mouth based on an image photographing unit 100 to create a plurality of oral images 120, and then compare the created plurality of oral images 120 and a teeth template image 140, and create a 3D image (3D oral image) of the patient's mouth 160.

Specifically, based on the teeth template image 140 of humans, the 3D oral image creating device may obtain information on whether or not the patient's individual teeth exist, location information on the individual teeth (3D coordinate information) and shape information on the individual teeth. The teeth template image 140 is a 3D templet image for comparing and analyzing with the oral image of the patient. The teeth template image 140 may include teeth information such as information on a molar tooth, premolar tooth, canine tooth, lateral incisor tooth and central incisor tooth located at an upper right jaw, upper left jaw, lower right jaw and lower left jaw of a person, respectively. Based on the teeth template image 140 and the plurality of oral images 120 of a patient, information on the presence of a tooth (molar tooth, premolar tooth, canine tooth, lateral incisor tooth and central incisor tooth, etc.) each located at the upper right jaw, upper left jaw, lower right jaw and lower left jaw of a person, information on the location of the teeth, and information on the shape of the teeth may be obtained.

For example, by matching the information on a central incisor tooth at an upper right jaw included in the teeth template image 140 (including the location information and shape information on the central incisor tooth at the upper right jaw) and the information on the plurality of oral images 120 of the patient, information on the presence of the central incisor tooth at the upper right jaw of the patient, 3D coordinate information and shape information may be obtained.

The 3D oral image creating device may create a patient's 3D oral image 160 based on the presence of an individual tooth, 3D coordinate information and shape information obtained. A procedural fixture device may be created based on the created 3D oral image 160 of the patient. Further, a procedure of removing tooth may be performed using an automatic tooth removing device based on the created 3D oral image 160 of the patient.

The procedural fixture device may be created in consideration of a certain tooth of the patient, for example, the location and shape of a lateral incisor tooth or a central incisor tooth, and fixate the mouth of the patient during the procedure of removing tooth.

According to an embodiment of the present disclosure, the procedural fixture device may be created such that, if a certain tooth of a patient does not exist, the patient's mouth can be fixated using another tooth of the patient that exists in consideration of the patient's tooth that does not exist.

For example, the procedural fixture device may be created using a device such as a 3D printer configured to create 3D structures. When a patient's 3D oral image is input into the 3D printer, the 3D printer may create the procedural fixture device based on information on the 3D oral image of the patient.

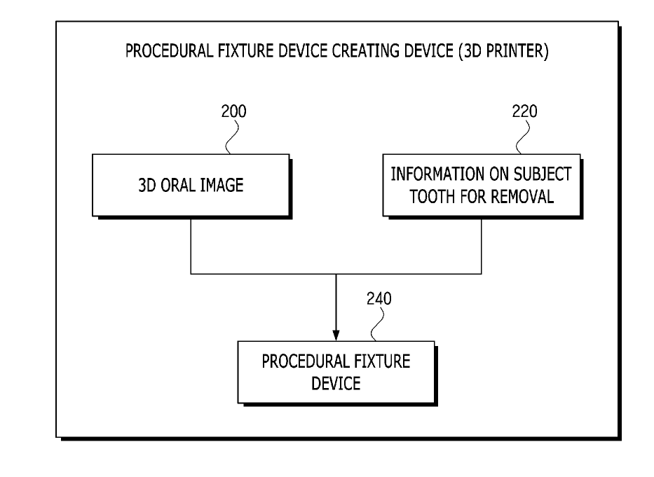

FIG. 2 is a view illustrating the concept of a method for creating the procedural fixture device according to an embodiment of the present disclosure.

Referring to FIG. 2, the procedural fixture device 240 may be created in consideration of the part of the patient from which a portion of a tooth has to be removed. For example, when a portion of a moral tooth located at an upper right jaw needs to be removed, the procedural fixture device 240 may be created such that the hand piece that will be connected to the automatic tooth removing device may easily approach the moral tooth located at the upper right jaw without blocking the moral tooth located at the upper right jaw in order to remove a portion of the moral tooth located at the upper right jaw.

In another example, when a portion of a central incisor tooth at the lower left jaw needs to be removed, the procedural fixture device 240 may be created such that the hand piece that will be connected to the automatic tooth removing device may easily approach the central incisor tooth located at the lower left jaw without blocking the central incisor tooth located at the lower left jaw in order to remove a portion of the central incisor tooth located at the lower left jaw.

That is, according to an embodiment of the present disclosure, the procedural fixture device 240 may be created in consideration of not only the 3D oral image 200 but also additionally in consideration of the information 220 on the patient's subject tooth for removal.

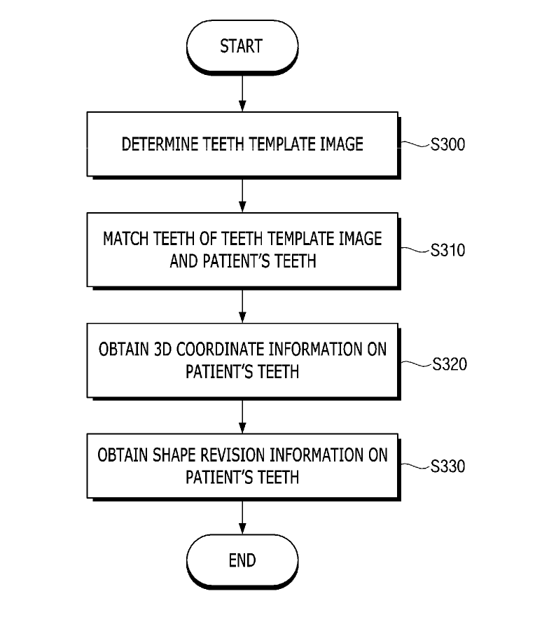

FIG. 3 is a view illustrating the concept of a method for obtaining a patient's 3D oral image according to an embodiment of the present disclosure.

FIG. 3 illustrates the method for obtaining a patient's 3D oral image of the 3D oral image creating device.

Referring to FIG. 3, a teeth template image for creating a 3D oral image of the patient is determined (step S300).

The teeth template image of the person stored in the 3D oral image creating device may include a first teeth template image where a wisdom tooth exists, and a second teeth template image where a wisdom tooth does not exist.

The first teeth template image where a wisdom tooth exists may be a 3D templet image of thirty-two teeth, and the second teeth template image where a wisdom tooth does not exist may be a 3D templet image of twenty-eight teeth.

The 3D oral image creating device may determine whether or not a wisdom tooth of a patient exists based on a plurality of oral images of the patient, and create the 3D oral image of the patient based on the first teeth template image or the second teeth template image. For example, when it is determined based on the plurality of oral images of the patient that there is at least one wisdom tooth among the teeth of the patient, the 3D oral image creating device may use the first teeth template image. On the contrary, when it is determined based on the plurality of oral images of the patient that there is no wisdom tooth among the teeth of the patient, the 3D oral image creating device may use the second teeth template image.

Otherwise, the 3D oral image creating device may store different teeth template images depending on the gender or age of the patient and use different teeth template images depending on the gender or age of the patient. That is, in an embodiment of the present disclosure, it is possible to determine a teeth template image that has the highest similarity with the oral condition of the patient based on the plurality of oral images of the patient, and create the 3D oral image of the patient.

Hereinbelow, it is assumed that a patient has a wisdom tooth and thus the first teeth template image is used. For convenience of explanation, it is assumed that number indexes from 1 to 32 are assigned to thirty-two teeth.

Teeth of a teeth template image and teeth of the patient are matched (step S310).

When using the first teeth template image, each of the thirty-two teeth (number 1 to number 32 teeth) included in the first teeth template image and each of the entirety of teeth at the upper right jaw, upper left jaw, lower right jaw, and lower left jaw, included in the plurality of oral images of the patient may be matched to each other. If certain teeth do not match, it may be determined that the corresponding tooth does not exist. Through such a matching process, each of the teeth included in the plurality of oral images of the patent may be matched to each of number 1 to number 32 teeth, and indexes (for example, number 1 to number 32) may be assigned. Hereinbelow, for convenience of explanation, it is assumed that the patient has all the teeth from number 1 to number 32.

3D coordinate information on the teeth of the patient matched based on the teeth template image is obtained (step S320).

In order to determine location information on the matched number 1 to number 32 teeth of the patient, information on a distance between the teeth may be obtained based on the plurality of oral images of the patient. For example, the location information of each of the number 1 to number 32 teeth of the patient may be obtained in 3D coordinates based on the information on distances between symmetric teeth at the upper left jaw and the upper right jaw, distances between symmetric teeth at the lower left jaw and the lower right jaw, symmetric teeth at the upper left jaw and the lower right jaw, and distances between symmetric teeth at the upper left jaw and the upper right jaw of the patient.

Shape revision information on the teeth of the patient matched based on the teeth template image is obtained (step S330).

Further, the shape information on each of the number 1 to number 32 teeth of the patient is compared with the shape information on each of the number 1 to number 32 teeth included in the first teeth template image, and the shape revision information may be obtained, which is information on a difference between the shape of the teeth in the first teeth template image and the shape of the teeth of the patient.

The 3D oral image creating device may revise the first teeth template based on the location information and shape revision information on each of the number 1 to number 32 teeth of the patient and create a 3D oral image of the patient.

As aforementioned, the procedural fixture device may be created based on the 3D oral image of the patient and the information on the subject tooth for removal of the patient.

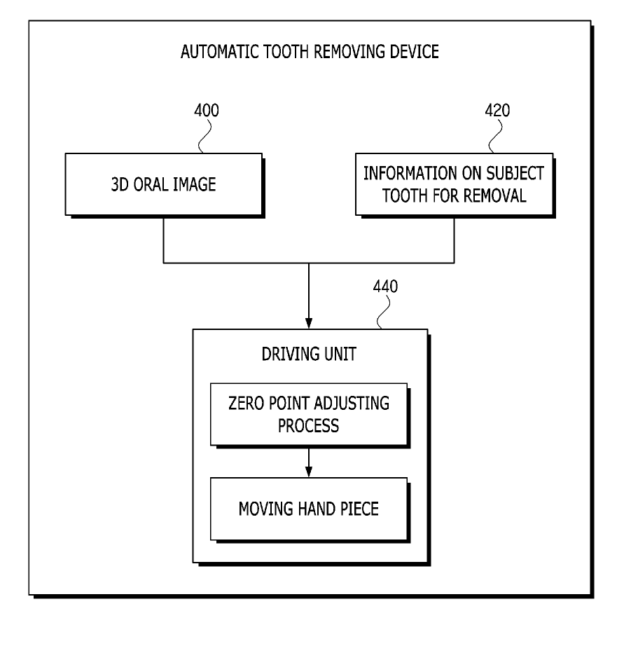

FIG. 4 is a view illustrating the concept of an automatic tooth removing device according to an embodiment of the present disclosure.

FIG. 4 illustrates the automatic tooth removing device configured to fixate a patient's mouth with the procedural fixture device and then to perform a tooth removing operation on the subject tooth for removal.

Referring to FIG. 4, the automatic tooth removing device may be configured to move and drive a hand piece and perform a procedure of removing tooth. The automatic tooth removing device may receive information 420 on a subject tooth for removal and information 400 on a 3D oral image of the patient, and perform a tooth removing operation on the subject tooth for removal.

For example, the automatic tooth removing device may include a driving unit configured to move a hand piece in 3 axis directions. The driving unit may be configured to move the hand piece in x axis, y axis and z axis directions and rotate the hand piece. As aforementioned, the location information and shape information on each of number 1 to number 32 teeth of the patient may be obtained based on the 3D oral image 400 of the patient. In the case of inputting the information 420 on the subject tooth for removal (for example, the number of the subject tooth for removal), the driving unit 440 of the automatic tooth removing device may move the hand piece to a position corresponding to the subject tooth for removal and proceed the procedure of removing a portion of the tooth.

According to an embodiment of the present disclosure, a zero point adjustment may be performed before the procedure of removing tooth of the hand piece. For example, a certain target point of the procedural fixture device may be designated as an operation point of the hand piece. Then, the hand piece may move exactly to the designated certain target point of the procedural fixture device and determine whether or not to proceed an operation of removing a portion of the tooth. If there is a difference between the certain target point and the operation point of the hand piece, the zero point may be adjusted by reducing the gap between the input point and the moved point of the hand piece through a zero point adjusting process.

After the zero point adjusting process, the automatic tooth removing device may move the hand piece to the subject tooth for removal corresponding to the input number of the subject tooth for removal. The hand piece that moved to the subject tooth for removal may proceed the procedure of removing tooth.

The automatic tooth removing device may obtain the shape information on the subject tooth for removal based on the patient's 3D oral image stored, and proceed the procedure of removing tooth by only the necessary amount of thickness without removing too much of the subject tooth for removal in consideration of the shape information on the subject tooth for removal.

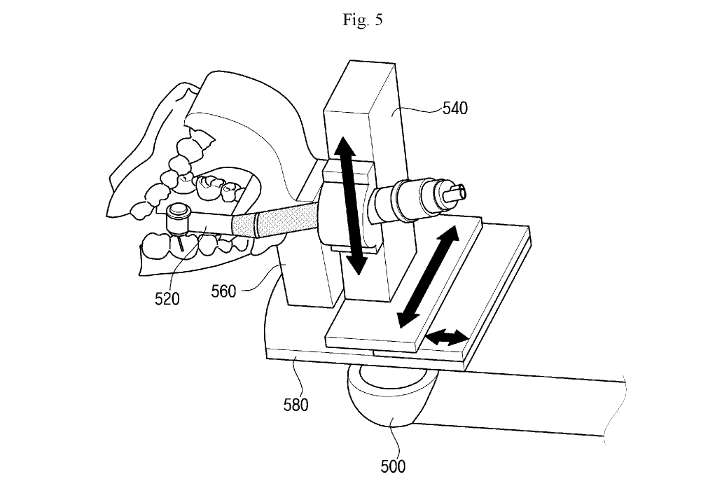

FIG. 5 is an image illustrating the operation of removing tooth of the automatic tooth removing device according to an embodiment of the present disclosure. FIG. 5 illustrates the automatic tooth removing device based on a virtual 3D image of a patient's mouth.

The automatic tooth removing device may be configured to move the hand piece 520 based on the movement of the driving unit 500.

Specifically, the driving unit 500 of the automatic tooth removing device may be configured to include a hand piece fixture support 540 for fixating the hand piece and a procedural fixture device support 580 for fixating the procedural fixture device 560, and the driving unit 500 of the automatic tooth removing device may move the hand piece fixture support 540 and the procedural fixture device support 580 mutually relatively or absolutely, thereby ultimately moving the hand piece 520.

In the illustrated example, the procedural fixture device support 580 is configured to include a first plate configured to move in a first direction, and a second plate configured to move in a second direction that is perpendicular to the first direction, and the hand piece fixture support 540 may be configured to include a third plate configured to move in a third direction that is perpendicular to both the first direction and the second direction.

Accordingly, the hand piece 520 becomes movable to any location on 3D space.

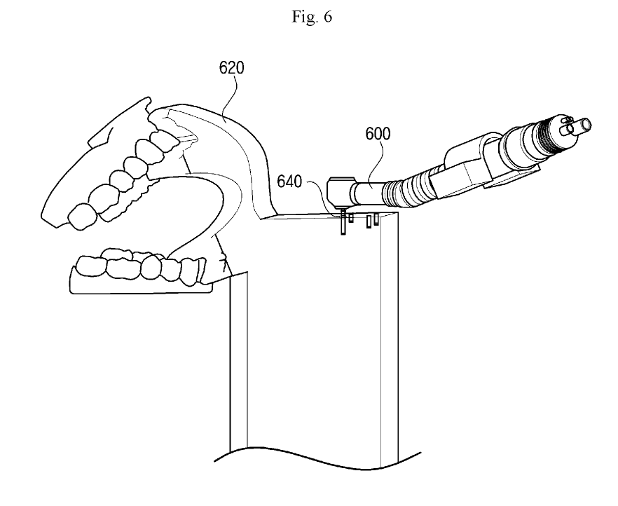

FIG. 6 is a view illustrating the concept of a zero point adjusting process according to an embodiment of the present disclosure.

FIG. 6 illustrates the zero point adjusting process that is performed before the operation of removing tooth of the hand piece.

Referring to FIG. 6, in the procedural fixture device 620, a certain target point 640 for zero adjustment may be designated.

Location information on the certain target point 640 may be input into the automatic tooth removing device for the zero point adjusting process. The automatic tooth removing device that received the location information on the certain target point 640 may move the hand piece 600 to the certain target point 640 based on the driving unit, and perform the operation of removing tooth.

The automatic tooth removing device may obtain information on a difference of location between the point where the tooth removing operation was performed and the certain target point 640.

For example, an image photographing unit may be realized in the hand piece 600 as well, and the image photographing unit realized in the hand piece 600 may photograph an image regarding the certain target point 640 and the point where the tooth removing operation was performed in order to obtain the information on the difference between the point where the tooth removing operation was performed and the certain target point 640. The automatic tooth removing device may analyze the image regarding the certain target point 640 and the point where tooth removing operation was performed to obtain the information on the difference between the certain target point 640 and the point where the tooth removing operation was performed, and may adjust the zero point for movement of the hand piece 600 based on the obtained information. Otherwise, a separate value for the zero point adjustment may be input by a tooth removing operation manager.

The hand piece 600 that adjusted the zero point may move to the subject tooth for removal based on the location information on the subject tooth for removal. The hand piece 600 that moved to the subject tooth for removal may perform a tooth removing operation.

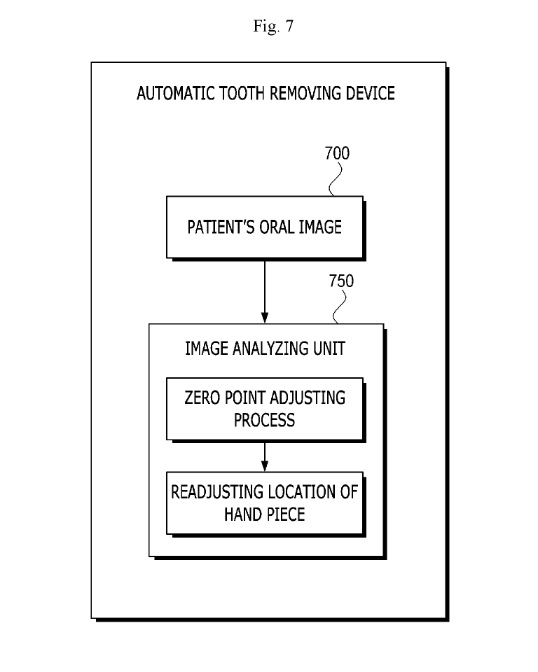

FIG. 7 is a view illustrating the concept of a method for removing tooth based on the hand piece inside a mouth according to an embodiment of the present disclosure.

FIG. 7 illustrates a method for readjusting the zero point of the hand piece according to the movement of a patient.

Referring to FIG. 7, a patient may move during the tooth removing operation, and the location of the zero point of the hand piece may be continuously adjusted in consideration of such a movement of the patient.

The image photographing unit realized in the hand piece may photograph a patient's mouth periodically, and transmit the photographed oral image 700 of the patient to an image analyzing unit 750 of the automatic tooth removing device. The image analyzing unit 750 of the automatic tooth removing device may analyze the oral image 700 of the patient photographed by the image photographing unit realized in the hand piece, detect a change in the current location on the 3D coordinate of the thirty-two teeth of the patient, and adjust the location of the subject tooth for removal on the 3D coordinate.

For example, the image analyzing unit 750 of the automatic tooth removing device may detect the change in the distances between symmetric teeth at the upper left jaw and the upper right jaw, distances between symmetric teeth at the lower left jaw and the lower right jaw, symmetric teeth at the upper left jaw and the lower right jaw, and distances between symmetric teeth at the upper left jaw and the upper right jaw, and sense the change in the location of the subject tooth for removal on the 3D coordinate.

For example, in a case where a patient moves his/her head by a certain angle to the left side, the automatic tooth removing device may sense the change in the location of the subject tooth for removal caused by the movement of the patient based on the patient's oral image 700 photographed by the image photographing unit realized in the hand piece. The automatic tooth removing device may move the location of the hand piece in consideration of the change in the location of the subject tooth for removal.

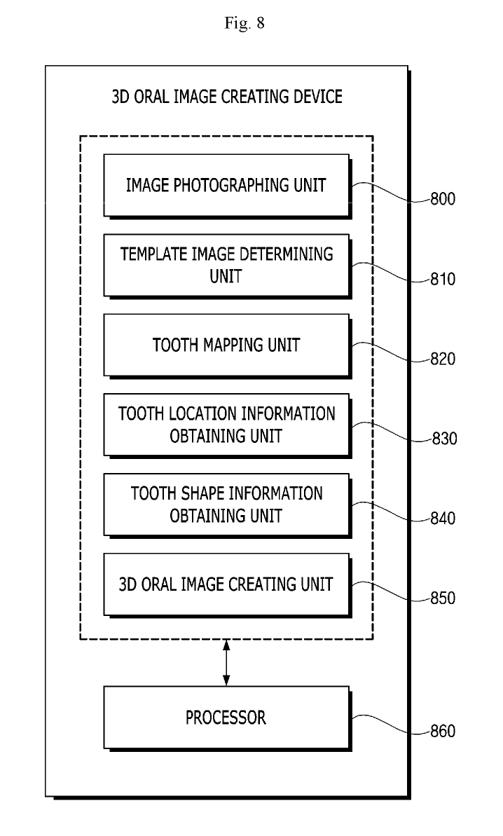

FIG. 8 is a block diagram illustrating the 3D oral image creating device according to an embodiment of the present disclosure.

Referring to FIG. 8, the 3D oral image creating device may include an image photographing unit 800, a template image determining unit 810, a tooth mapping unit 820, a tooth location information obtaining unit 830, a tooth shape information obtaining unit 840, a 3D oral image creating unit 850 and a processor 860.

The image photographing unit 800 may be configured to photograph a patient's mouth in order to create a 3D oral image of the patient. The image photographing unit 800 may be configured to performing photographing teeth located inside the patient's mouth such as the teeth at the upper right jaw, the upper left jaw, the lower right jaw and the lower left jaw of the patient.

The template image determining unit 810 may be configured to determine a teeth template image that is most similar to a patient's oral condition in order to create the 3D oral image of the patient. For example, the template image determining unit 810 may determine the teeth template image in consideration of the presence of wisdom tooth of the patient, gender, age, size of the upper jaw and the size of the lower jaw of the patient and the like.

The tooth mapping unit 820 may be configured to perform mapping of each of the teeth (for example, number 1 to number 32 teeth) of the patient and each of the teeth (for example, number 1 to number 32 teeth) included in the teeth template image based on the patient's oral image photographed by the image photographing unit 800 and the teeth template image determined by the template image determining unit 810.

The tooth location information obtaining unit 830 may be configured to obtain the 3D coordinate information on each of the teeth of the patient. For example, the tooth location information obtaining unit 830 may be configured to obtain the 3D coordinate information on each of the teeth based on the distances between symmetric teeth at the upper left jaw and the upper right jaw, distances between symmetric teeth at the lower left jaw and the lower right jaw, distances between symmetric teeth at the upper left jaw and the lower right jaw, and distances between symmetric teeth at the upper left jaw and the upper right jaw of the patient.

The tooth shape information obtaining unit 840 may be configured to create the shape revision information through a comparison between the shape information of each of the teeth included in the teeth template image and the shape information on each of the teeth of the patient.

The 3D oral image creating unit 850 may be configured to create a 3D oral image of the patient based on the 3D coordinate information and the shape revision information on each of the teeth of the patient.

The processor 860 may be configured to control operations of the image photographing unit 800, the template image determining unit 810, the tooth mapping unit 820, the tooth location information obtaining unit 830, the tooth shape information obtaining unit 840 and the 3D oral image creating unit 850.

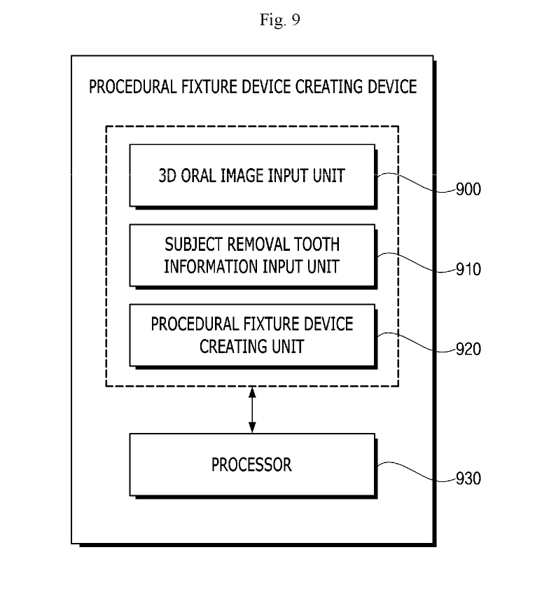

FIG. 9 is a block diagram illustrating the procedural fixture device creating device according to an embodiment of the present disclosure.

Referring to FIG. 9, the procedural fixture device creating device may include a 3D oral image input unit 900, a subject removal tooth information input unit 910, a procedural fixture device creating unit 920 and a processor 930.

The 3D oral image input unit 900 may be configured to receive input of the 3D oral image created by the 3D oral image creating device.

The subject removal tooth information input unit 910 may be configured to receive information on the patient's subject tooth for removal.

The procedural fixture device creating unit 920 may be configured to create the procedural fixture device based on the patient's 3D oral image and information on the patient's subject tooth for removal.

The processor 930 may be configured to control operations of the 3D oral image input unit 900, the subject removal tooth information input unit 910 and the procedural fixture device creating unit 920.

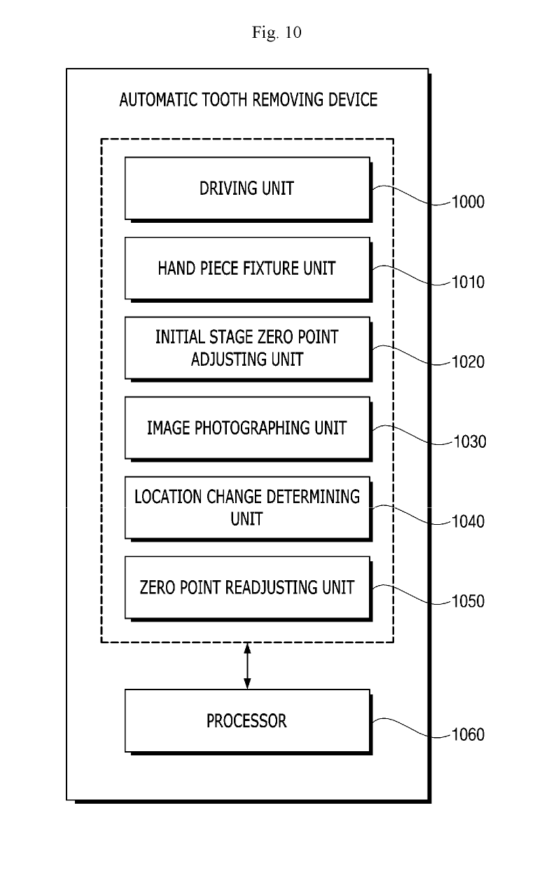

FIG. 10 is a block diagram illustrating the automatic tooth removing device according to an embodiment of the present disclosure.

Referring to FIG. 10, the automatic tooth removing device may include a driving unit 1000, a hand piece fixture unit 1010, an initial stage zero point adjusting unit 1020, an image photographing unit 1030, a location change determining unit 1040, a zero point readjusting unit 1050 and a processor 1060.

The driving unit 1000 may be configured to drive the hand piece for the operation of removing tooth. The driving unit 1000 may be configured to perform 3 axis movement and rotating movement to move the hand piece to the subject tooth for removal, and proceed the operation of removing tooth in a predetermined thickness based on the hand piece.

The hand piece fixture unit 1010 may be configured to fixate the hand piece for the operation of removing tooth.

The initial stage zero point adjusting unit 1020 may be configured to adjust an initial stage zero point prior to proceeding the operation of removing tooth. The initial stage zero point adjusting unit 1020 may be configured to perform the initial stage zero point adjustment based on whether or not the hand piece moved to a certain target point designated in the procedural fixture device.

The image photographing unit 1030 may be configured to photograph the oral image of the patient periodically or non-periodically in order to determine the movement of the patient.

The location change determining unit 1040 may be configured to determine the information on the change in location of the patient during a procedure by the image photographed by the image photographing unit 1030.

The zero point readjusting unit 1050 may be configured to newly determine the zero point of the hand piece in consideration of the information on the change in location determined by the location change determining unit 1040 so that the hand piece can be moved exactly to the subject tooth for removal and proceed the operation.

The processor 1060 may be configured to control operations of the driving unit 1000, the hand piece fixture unit 1010, the initial stage zero point adjusting unit 1020, the image photographing unit 1030, the location change determining unit 1040, and the zero point readjusting unit 1050.

At least two of the 3D oral image creating device, the procedural fixture device creating device and the automatic tooth removing device illustrated in FIGS. 8 to 10 may be configured as one automatic tooth removing system, and such embodiments are also included in the scope of right of the present disclosure.

Further, although the 3D oral image creating device, the procedural fixture device creating device and the automatic tooth removing device were expressed separately from one another for convenience of explanation, functions of each of the 3D oral image creating device, the procedural fixture device creating device and the automatic tooth removing device may be combined and realized as one device constituting another form of automatic tooth removing system.

Such a dental precision procedural method may be realized in an application or realized in the form of a program command that may be performed through various computer configuration elements and be recorded in a computer readable record medium. The computer readable record medium may include a program command, a data file, a data structure and the like solely or in combinations.

The program command being recorded in the computer readable record medium may be one that is specially designed and configured for the present disclosure or one that is well-known to and thus available by those skilled in the computer software field.

Examples of the computer readable record medium include magnetic media such as hard disk, floppy disk and magnetic tape, optical record media such as CD-ROM and DVD, magneto-optical media such as floptical disk, and hardware devices specially configured to store and perform program commands such as ROM, RAM and flash memory, etc.

Examples of such program commands include not only machine language codes such as those created by compilers but also high-level language codes that may be executed by computers using interpreters and the like. These hardware devices may be configured to operate as one or more software modules to perform the processes of the present disclosure, and vice versa.

The right of the scope of the present disclosure is not limited to the aforementioned embodiments but may be realized in various types of embodiments within the claims attached hereto. It will be apparent to one of ordinary skill in the art that various changes in form and details may be made in these examples without departing from the spirit and scope of the claims and their equivalents.

1. A dental precision procedural method comprising:
creating information on a 3D oral image by photographing a patient's mouth;
creating a procedural fixture device to fixate the patient's mouth when performing a procedure of removing a tooth of the patient based on the information on the 3D oral image; and
moving a hand piece to a subject tooth for removal of the patient based on the information on the 3D oral image, and performing the procedure of removing the subject tooth.

2. The method of claim 1,
wherein the hand piece is moved to the subject tooth for removal by a driving unit, and
the driving unit moves the hand piece in 3 axis directions based on 3D coordinate information on the subject tooth for removal obtained based on the information on the 3D oral image.

3. The method of claim 2,
wherein the driving unit determines whether or not to move the hand piece to a target point indicated on the procedural fixture device before moving the hand piece to the subject tooth for removal, and adjusts a zero point between the 3 axis movement of the driving unit and the 3D coordinate information on the subject tooth for removal.

4. The method of claim 3,
wherein the creating the information on the 3D oral image comprises:
determining a teeth template image for creating the information on the 3D oral image based on a plurality of oral image information of the patient;
matching each template tooth included in the teeth template image and each tooth of the patient included in the plurality of oral image information;
obtaining the 3D coordinate information on the each tooth of the patient;
obtaining shape revision information on the each tooth of the patient; and
creating the information on the 3D oral image based on the 3D coordinate information on the each tooth of the patient and the shape revision information on the each tooth of the patient,
wherein the shape revision information comprises information on a difference between a shape of the each template tooth and a shape of the each tooth of the patient included in the oral image information.

5. The method of claim 4,
wherein the teeth template image is determined based on the patient's gender, the patient's age, information on characteristics of an upper jaw and a lower jaw of the patient, and presence of a wisdom tooth of the patient.

6. A dental precision procedural system, the system comprising:
a 3D oral image creating device configured to create information on a 3D oral image of a patient;
a procedural fixture device creating device configured to create a procedural fixture device to create the patient's mouth when performing a procedure of removing a tooth of the patient based on the information on the 3D oral image; and
an automatic tooth removing device configured to move a hand piece to a subject tooth for removal of the patient based on the information on the 3D oral image, and to perform the procedure of removing the tooth.

7. The system of claim 6,
wherein the automatic tooth removing device comprises a driving unit,
the hand piece is moved to the subject tooth for removal by the driving unit, and
the driving unit moves the hand piece in 3 axis directions based on 3D coordinate information of the subject tooth for removal obtained based on the information on the 3D oral image.

8. The system of claim 7,
wherein the driving unit determines whether or not to move the hand piece to a target point indicated on the procedural fixture device before moving the hand piece to the subject tooth for removal, and adjusts a zero point between the 3 axis movement of the driving unit and the 3D coordinate information of the subject tooth for removal.

9. The system of claim 8,
wherein the 3D oral image creating device is configured to determine a teeth template image for creating the information on the 3D oral image based on a plurality of oral image information of the patient,
match each template tooth included in the teeth template image and each tooth of the patient included in the plurality of oral image information,
obtain the 3D coordinate information on the each tooth of the patient,
obtain shape revision information on the each tooth of the patient, and
create the information on the 3D oral image based on the 3D coordinate information on the each tooth of the patient and the shape revision information on the each tooth of the patient,
wherein the shape revision information comprises information on a difference between a shape of the each template tooth and a shape of the each tooth of the patient included in the oral image information.

10. The system of claim 9,
wherein the teeth template image is determined based on the patient's gender, the patient's age, information on characteristics of an upper jaw and a lower jaw of the patient, and presence of a wisdom tooth of the patient.
